(19) United States
(12) Patent Application Publication
(10) Pub. No.: US 2018/0192633 A1
(43) Pub. Date: Jul. 12, 2018

(54) Multiplex Waterfowl Call

(71) Applicant: Roderick Stanford Truax, II, Sulphur, LA (US)

(72) Inventor: Roderick Stanford Truax, II, Sulphur, LA (US)

(21) Appl. No.: 15/399,876

(22) Filed: Jan. 6, 2017

(51) Int. Cl. A01M 31/00

(52) U.S. Cl. CPC A01M 31/004

(57) ABSTRACT

A duck call or game call that can provide several different species of waterfowl sounds contained in one individual game call. The call consists of four main parts; the head, body, reed assembly, and the tail. The head assembly rotates either clockwise or counter clockwise to align the head with appropriate chamber in the body to produce the users desired waterfowl sound. The reed assembly can be changed out to produce the waterfowl sounds desired by the user for his/her area.

### FIELD OF INVENTION

The present invention relates generally to the field of animal game calls. More specifically, the invention relates to the field of waterfowl game calls.

### BACKGROUND OF THE INVENTION

Traditionally, waterfowl hunting generally involves the use of many different items such as a shotgun, hunting blind, boat or ATV, waterfowl decoys, and waterfowl calls. The “Waterfowl Call” is a mechanical device in which the user blows into one end, much like a musical wind instrument, but to simulate the sound made by the waterfowl. The waterfowl calls are used in a manner to lure or entice the waterfowl close to the waterfowl decoys to provide a close shot for the pursuing hunter. Hunters usually carry the waterfowl calls on a lanyard. A “lanyard”, in general terms, is described as a necklace type device that consist of rope, leather, or string in which individual duck or goose calls are connected and placed around the hunters neck to access the calls.

This traditional method encounters various problems. One is that there are many species of waterfowl that make different sounds and different species are more prominent in different parts of the country. The traditional waterfowl call is designed to make one or more sounds that emulate that of prey, but of only one species. There are at least two dozen types of ducks presiding in North America, not including other waterfowl such as smews, scoters, eiders, loons, and mergansers. To name some, this includes the American Black Duck, American Widgeon, Golden Eye, Black-bellied Whistling Duck, Blue Winged Teal, Bufflehead, Canvasback, Cinnamon Teal, Gadwall, Green Winged Teal, Northern Shoveler, etc.

In addition to the various waterfowl calls for different species of waterfowl, waterfowl calls are also designed for different hunting environments. Different environments include open water hunting, which require a louder, high pitch sound, timber hunting, which require a softer, raspier sound, and field hunting which could be a combination of different sounds dependent on weather conditions.

Because of the wide variety of waterfowl species being hunted and the different environments in which waterfowl is being hunted, a Hunter's lanyard usually consists of an assortment of different waterfowl calls dependent on the region or area they preside resulting in a series of problems.

One common problem is that waterfowl is predominately active before sunrise and after sunset where little or no natural light is available. Because most waterfowl calls are relatively the same shape and size, often the hunter will mistakenly grasp and use the wrong call in an effort to lure in the waterfowl often having the reverse effect. Using a flashlight or other lighting device to see the waterfowl calls is considered taboo as it will deter waterfowl form the desired location.

Another common problem is that the average hunter has between 4 and 8 different waterfowl calls on his lanyard. Because the waterfowl calls are hanging downward from the lanyard, they tend to get twisted and tangled from continuous use thus resulting in untangling of the waterfowl calls and hunting down time.

The principal objective of the present invention is to provide multiple waterfowl calls in one housing for ease of use and to prevent the need for an over abundance of waterfowl calls in the hunting blind.

### BRIEF SUMMARY OF THE INVENTION

The present invention comprises a waterfowl call that can provide multiple, different waterfowl calls into one unit. Expectations are for the present invention to replace traditional, single waterfowl calls.

The present invention consists of a head, body, reed assembly, and the tail. Preferably the head will rotate in either a clockwise or counter clockwise direction on the upper end of the body. Mechanical stops will align the wind tunnel in the head to the desirable wind tunnel in the body.

Preferably the reed assembly is fastened into the lower end of the body in fixed position and contains the reeds to provide the desired waterfowl sound required by the individual. The reed assembly will be interchangeable to provide the desirable arrangement of reeds required by the user.

Preferably the tail is fastened to the lower portion of the body in a fixed position and provides an area to apply back pressure to reach the desired sound.

### BRIEF DESCRIPTION OF THE DRAWINGS

FIG. 1 is an orthographic view, showing the head section.

FIG. 2 is a cross sectional view of the head section.

FIG. 3 is a bottom view of the head section.

FIG. 4 is a top view of the head section.

FIG. 5 is an orthographic view, showing the head section and fastener.

FIG. 6 is a perspective view of the head section and fastener.

FIG. 7 is an orthographic view, showing the body section.

FIG. 8 is a cross sectional view of the body section.

FIG. 9 is a top view of the body section.

FIG. 10 is a perspective view, showing the body section.

FIG. 11 is an orthographic view, showing the reed assembly.

FIG. 12 is a cross sectional view of the reed assembly.

FIG. 13 is a top/bottom view of the reed assembly.

FIG. 14 is a perspective view, showing the reed assembly.

FIG. 15 is an orthographic view, showing the tail section.

FIG. 16 is a cross sectional view of the tail section.

FIG. 17 is a top view of the tail section.

FIG. 18 is a bottom view of the tail section.

FIG. 19 is a perspective view, showing the tail section.

FIG. 20 is an orthographic view showing the head section, body section, and reed assembly.

FIG. 21 is orthographic view, showing the waterfowl call assembled.

FIG. 22 is a perspective view, showing the waterfowl call assembled.

FIG. 23 is a diagram showing all entities.

### REFERENCE NUMERALS IN THE DRAWING

| | |
|---|---|
| 10 head | 12 body |
| 14 reed assembly | 16 tail |
| 18 fastener | 20 tension mechanism |
| 22 retention fastener | 24 mechanical alignment stops |
| 26 reed | 28 reed body |
| 30 reed retention | 32 gasket |

### DESCRIPTION OF THE PREFERRED EMBODIMENT

While this invention is susceptible in many different forms, there are shown in the drawings and will be described herein in detail specific embodiments thereof with the understanding that the present disclosure is to be considered as an exemplification of the principles of the invention and is not intended to limit the invention to specific embodiments illustrated.

As described herein, the embodiments of the subject invention are directed to a waterfowl call that can produce multiple species of waterfowl sounds. According to such embodiments, the waterfowl call can accommodate up to four different species of waterfowl thus eliminating the need for an exemplary amount of traditional, single specie waterfowl calls.

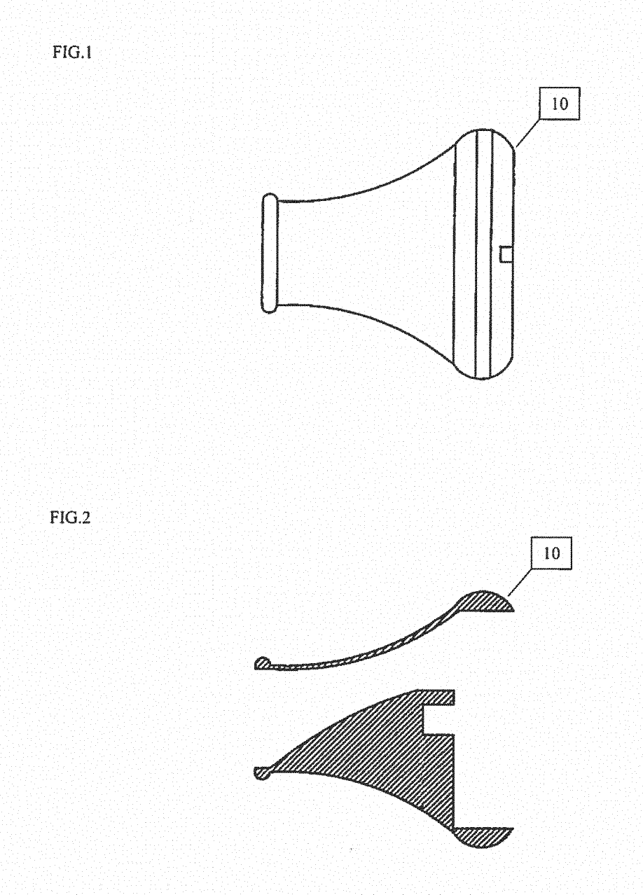

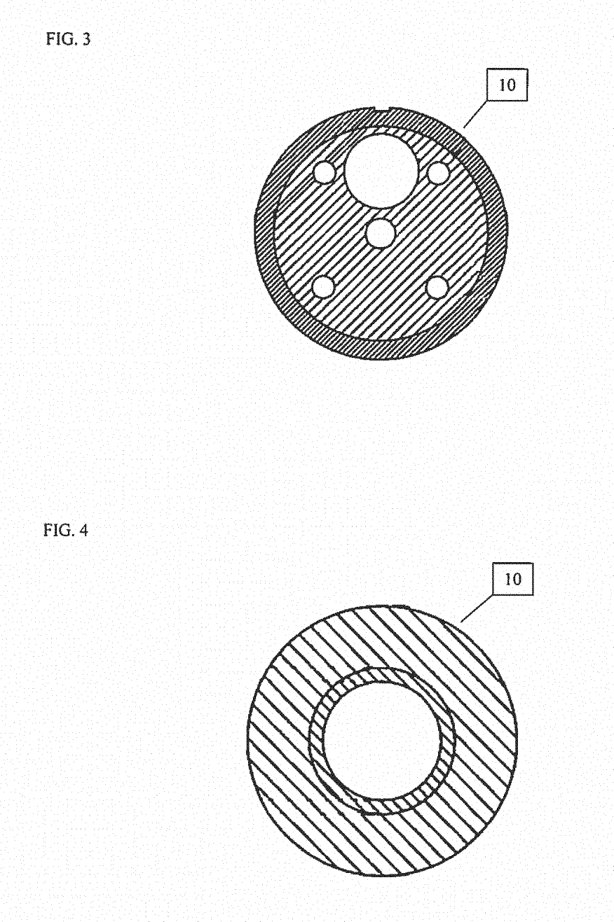

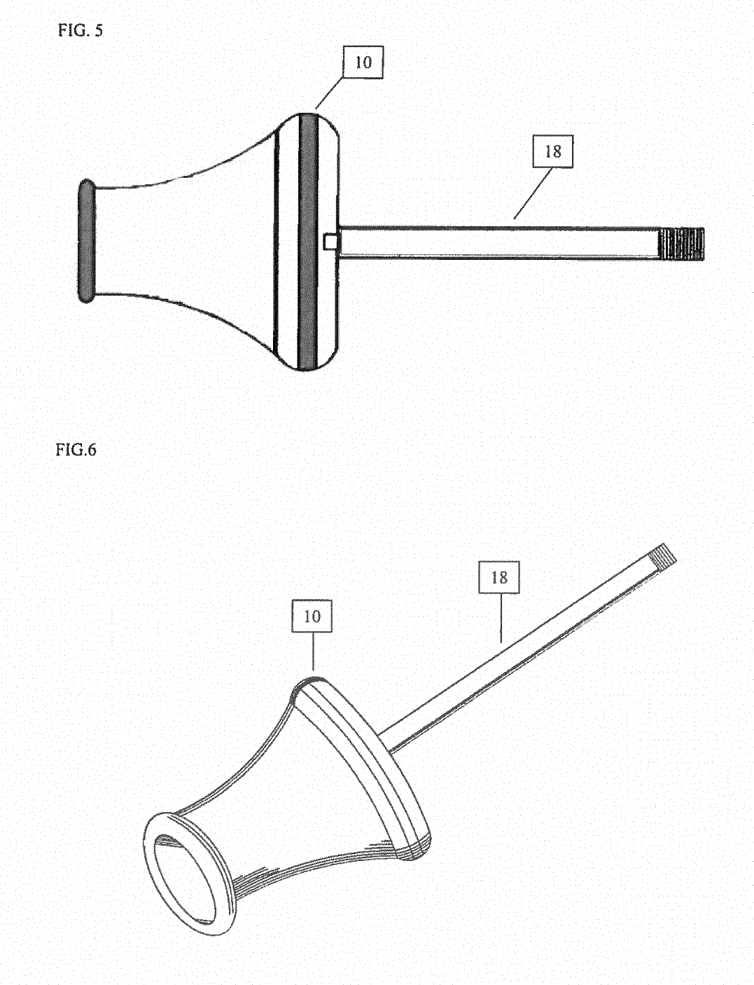

With reference now to the figures, FIG. 1-4 illustrates different views of the head section 10. The head section 10 is best described as the section in which air enters and is distributed to the desired location. As shown in FIG. 2, the air is channeled to one location thus allowing air flow to enter only one chamber of the body 12. This action prevents any unwanted sounds to created from any other chambers in the body 12.

FIGS. 5 and 6 illustrates the head section 10 and the fastener 18. The fastener 18 is bonded to the head section 10. The fastener 18 will be utilized to hold tension between the remainder of the parts.

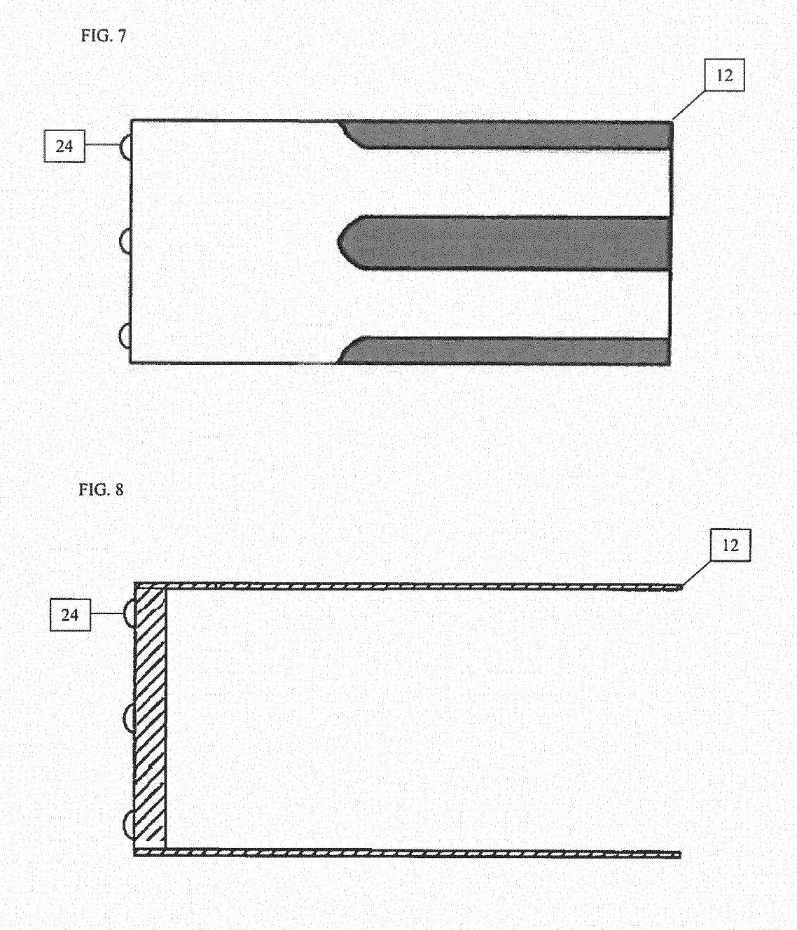

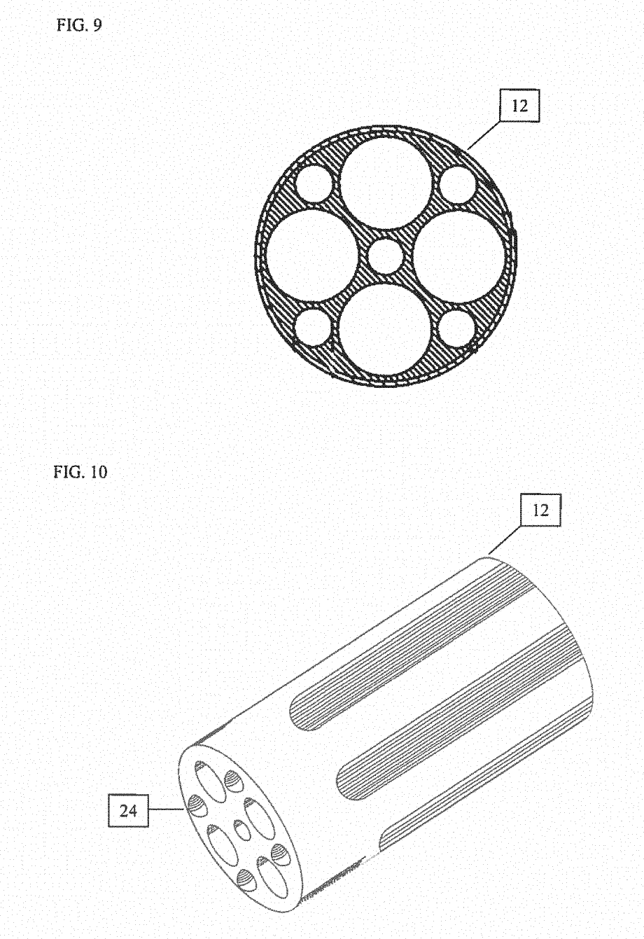

FIG. 7-10 illustrates the different views of the body 12. The body 12 is best described as the portion of the call in which contains the reed body 28. The reed body 28 is inserted to the body 12 which allows for case of changing or modifying the reeds 26. The mechanical alignment stops 24 located on the body 12 aligns the head section 10 with the appropriate chambers once the reed assembly 14 is inserted into the body 12.

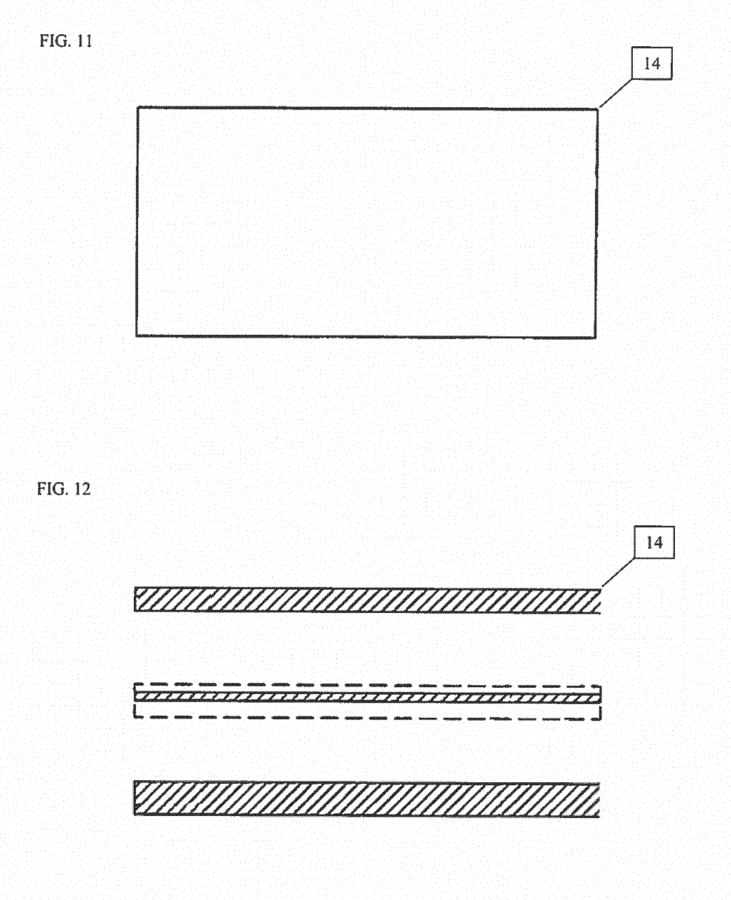

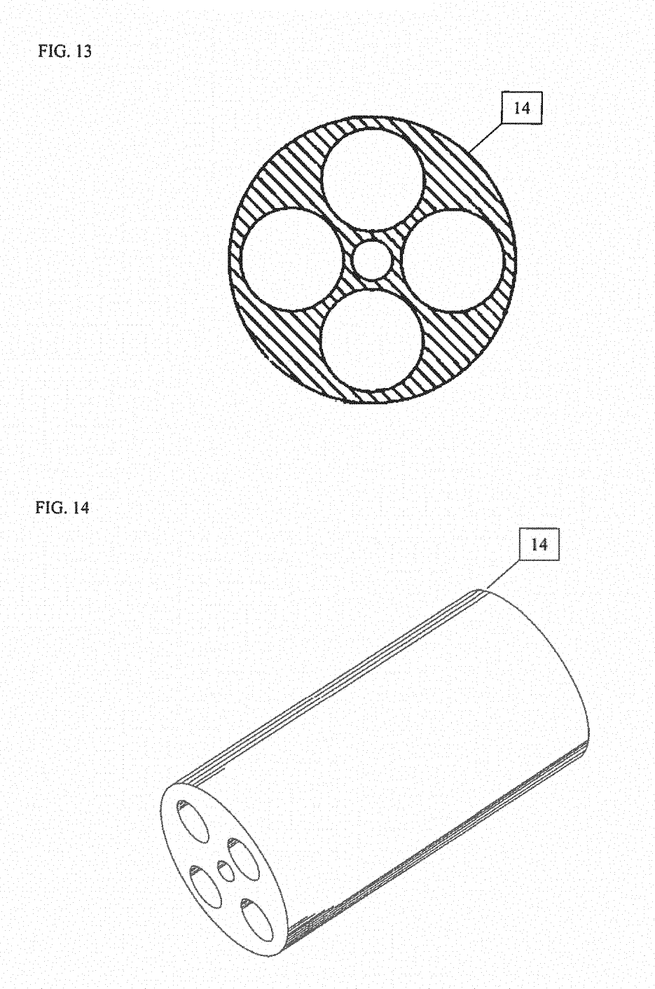

FIG. 11-14 illustrates the different views of the reed assembly 14. The reed assembly 14 contains the chambers in which the reed 26, reed body 28, and the reed retention 30 are assembled and installed in each of the chambers.

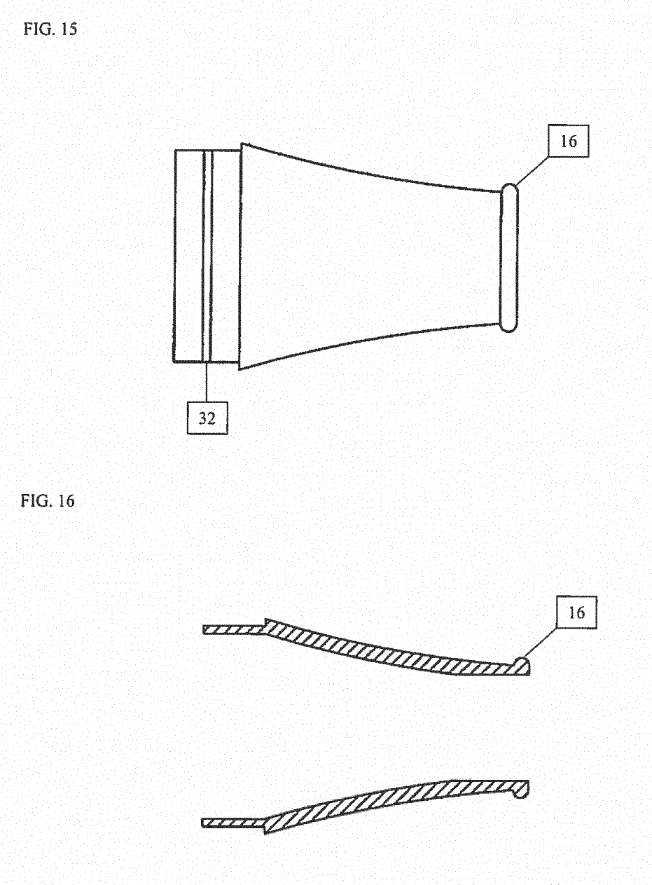

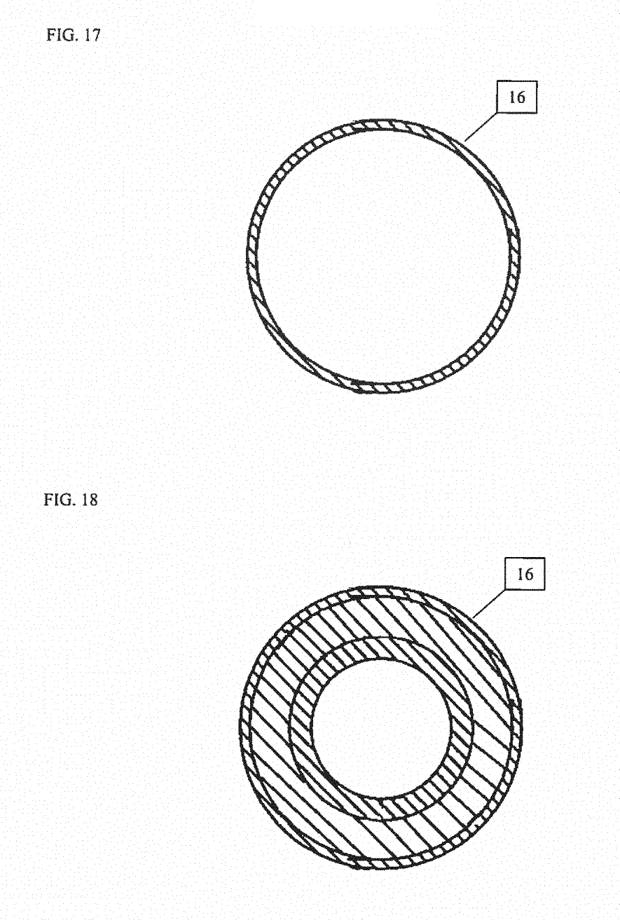

FIG. 15-19 illustrates the different views of the tail 16. The tail 16 is inserted into the end of the body 12 and is held in place with the use of a gasket 32. The tail 16 is best described as where the desired sound exits the waterfowl call.

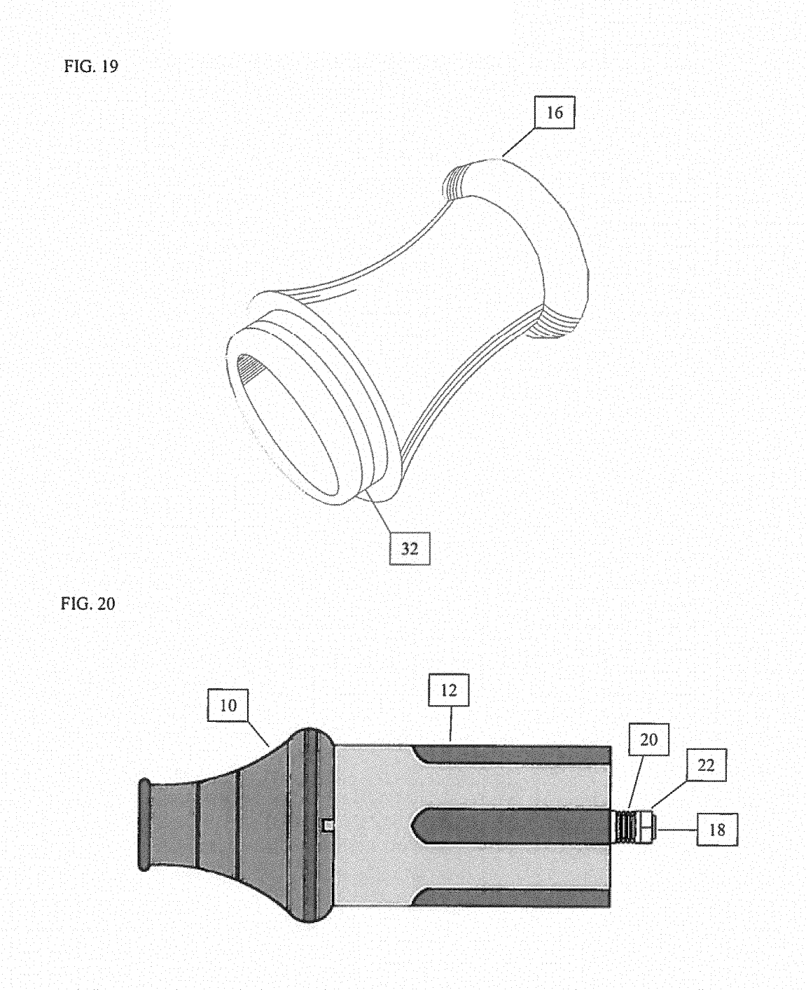

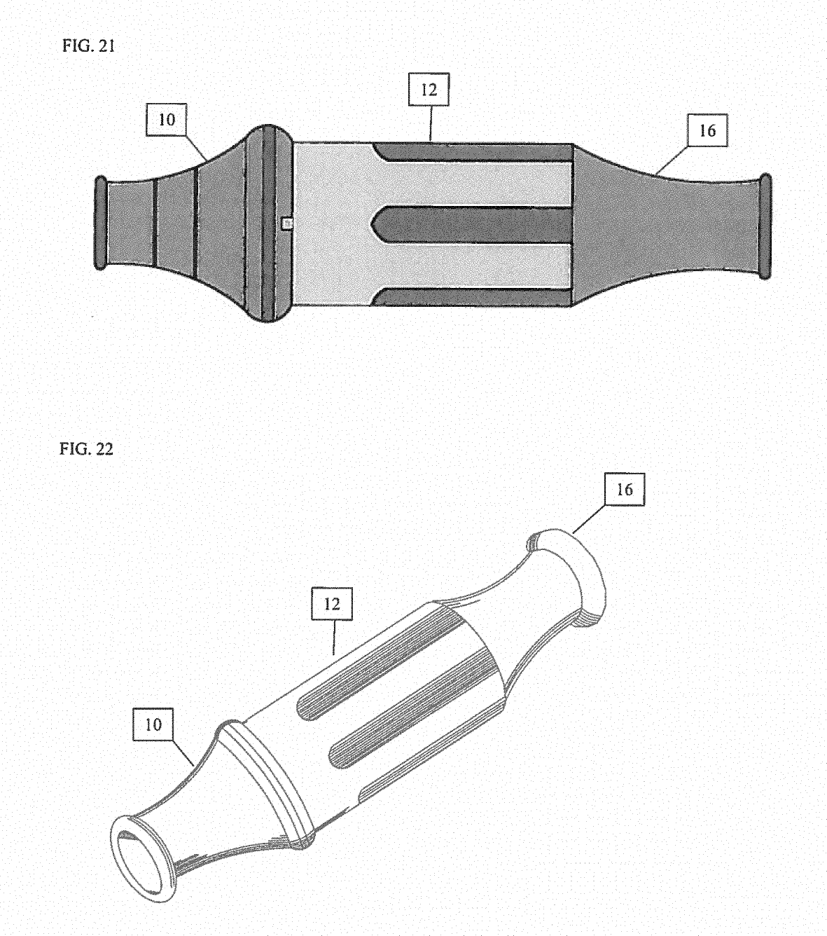

FIG. 20-22 illustrates the assembled waterfowl call as a whole. Beginning with FIG. 20, the head 10, with the fastener 18 attached, is fed through the body 12 and the reed assembly 14. The tension mechanism 20 is then placed on the fastener 18 and then the retention fastener 22. This allows for parts to stay together as well as allows for tension to be present when rotating the head 10 to the desired chamber to produce the desired waterfowl sound. FIGS. 21 and 22 illustrates different views of the waterfowl call once the tail 16 is installed.

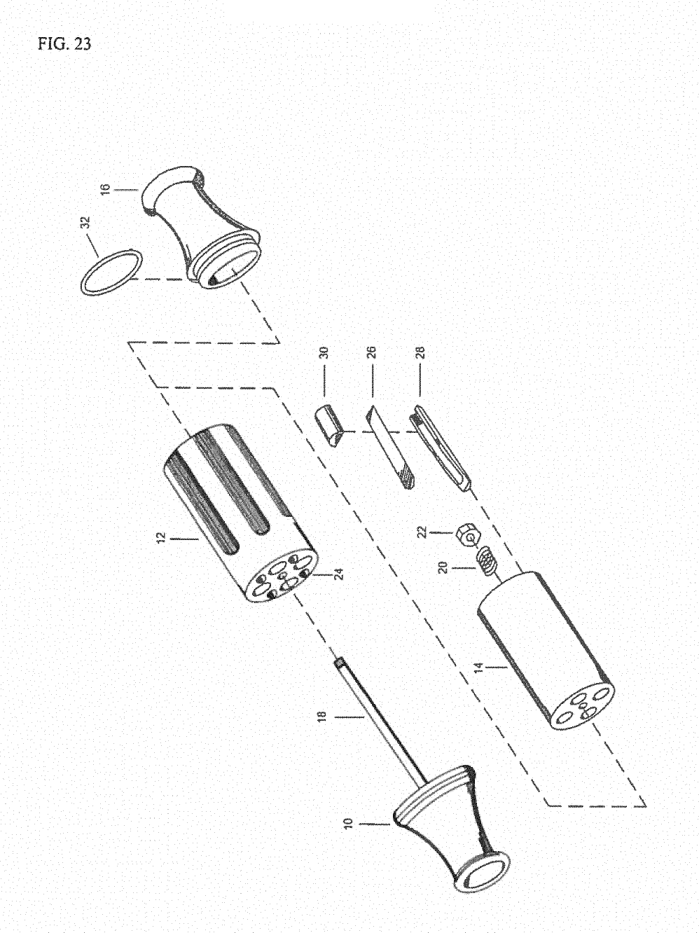

FIG. 23 is a diagram that shows all entities and how they are put together.

### FUNCTIONAL DESCRIPTION OF THE PREFERRED EMBODIMENT

Once the waterfowl call is put together, desired reeds 26 chosen and put in the reed assembly 14, the user is able to simply rotate the head 10 while holding the body 12 to allow for the proper chamber to align with assistance from the mechanical alignment stops 24 which will provide the desired sound to prevail to attract waterfowl. The reed assembly 14 can easily be changed out to provide different reeds 26 for different waterfowl applications.

Having described my invention, I claim:

1. A waterfowl call configured with but not limited to the ability to create four (4) unique waterfowl sounds, contained in one housing, by means of rotating one or more parts, clockwise or counter clockwise, in which a mechanical stop aligns an airway with different chambers to provide different waterfowl sounds and can be interchangeable to contain desired species of waterfowl.
